(19) United States
(12) Patent Application Publication
(10) Pub. No.: US 2010/0063825 A1
(43) Pub. Date: Mar. 11, 2010

(54) Systems and Methods for Memory Management and Crossfading in an Electronic Device

(75) Inventors: Joseph M. Williams, Dallas, TX (US); Richard Michael Powell, Mountain View, CA (US); Aram Lindahl, Menlo Park, CA (US)

Correspondence Address: APPLE INC.;c/o Fletcher Yoder, PC, P.O. Box 692289, Houston, TX, 77269-2289, US

(73) Assignee: Apple Inc., Cupertino, CA (US)

(21) Appl. No.: 12/205,649

(22) Filed: Sep. 5, 2008

(51) Int. Cl. G10L 21/00; G06F 17/00

(52) U.S. Cl. 704/500; 700/94; 704/E19.001

(57) ABSTRACT

Systems and methods are disclosed for the management of memory used in a crossfading operation in an electronic device. In one embodiment, a processor is used to alternately decode two audio streams, one which is being faded out and one which is being faded in to implement a crossfade. The two audio streams may be encoded in the same or different formats and may be alternately decoded such that resource usage is reduced. The amount of decoded data of both audio streams and other parameters may determine which audio stream is to be actively decoded. In certain embodiments, the decoded data may be stored in a circular buffer, and a delta is determined between the decoded data and the empty space of the buffer.

### BACKGROUND OF THE INVENTION

1. Field of the Invention

The present invention relates generally to data management in electronic devices, and more particularly to memory and decoder hardware management in such devices.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices are widely used for a variety of tasks. Among the functions provided by electronic devices, audio playback, such as playback of music, audiobooks, podcasts, lectures, etc., is one of the most widely used. The audio tracks played by such electronic devices may be stored in audio files encoded in a number of different formats. For example, some formats may include compressed formats, such as MPEG-1 Audio Layer 3 (MP3), Advanced Audio Coding (AAC), etc. Typically, the audio may be stored as a file in a non-volatile memory accessible to or integrated in the electronic device. The audio may then be decoded during playback via a specific decoder for each format (the encoder and decoder for a format are commonly referred to as a “codec”).

At any time, an electronic device may store or have access to files encoded in a variety of formats. For example, a device may access an audio file in MP3 format, another audio file in AAC format, etc. The availability and large numbers of formats ensures that different codecs will frequently be used to encode audio files for storage on an electronic device. Similarly, these different codecs may be used to decode the files during playback.

During playback, it may be desirable to have consecutive audio streams (i.e., audio tracks) “fade” in and out of each other. Such a technique is referred to as “crossfading.” A first stream may be slowly faded out, e.g., by decreasing the playback volume of the track, and a second stream may be slowly faded in, e.g., by increasing the playback volume of the track. If the first stream is encoded using a different codec than the second stream, however, both streams are decoded using different codecs. The resources of the electronic device may be insufficient to provide uninterrupted playback of two or more audio streams while decoding two streams using different codecs. Additionally, memory used to store each decoded audio stream may not be sufficiently managed with the decoding processes to ensure uninterrupted playback and elimination of audio artifacts (e.g., skipping, pauses, etc.). As electronic devices increase in portability and decrease in size, the corresponding decrease in available resources such as memory, processing power, battery life, etc. may limit the data decoding and memory management capabilities of the electronic device.

### SUMMARY

Certain aspects commensurate in scope with the originally claimed invention are set forth below. It should be understood that these aspects are presented merely to provide the reader with a brief summary of certain forms of the invention might take and that these aspects are not intended to limit the scope of the invention. Indeed, the invention may encompass a variety of aspects that may not be set forth below.

In one embodiment, a portable electronic device is provided that includes an audio processor and corresponding audio memory. The portable electronic device includes a storage having one or more audio files stored in various encoded formats. The audio processor decodes audio data from the encoded audio files and transmits the output, decoded data of an audio stream, to a memory buffer of the device. For a crossfade of two audio streams, the buffer may store enough data for each stream to be crossfaded in and out of the real-time output. To minimize size, heat, cost, power usage, and other parameters, the processor may be limited to decoding only one audio stream at a time and incapable of decoding two streams simultaneously. The processor can switch between decoders based on the duration of playback time, i.e., amount of data, stored in the buffer.

In one implementation, data of a first stream is decoded via a first decoder and stored in the buffer. The audio processor may switch to a second decoder based on the amount of decoded data stored in the buffer, and data of a second stream is decoded via the second decoder. A delta may be determined between the empty space of the buffer and the data of the first stream, and the first stream is decoded until the delta is full of the decoded data of the first stream.

### BRIEF DESCRIPTION OF THE DRAWINGS

Advantages of the invention may become apparent upon reading the following detailed description and upon reference to the drawings in which:

FIG. 1 is a perspective view illustrating an electronic device, such as a portable media player, in accordance with one embodiment of the present invention;

FIG. 2 is a simplified block diagram of the portable media player of FIG. 1 in accordance with one embodiment of the present invention;

FIG. 3 is a graphical illustration of crossfading of two audio streams in accordance with an embodiment of the present invention;

FIG. 4 is a simplified block diagram of decoder multiplexing in accordance with an embodiment of the present invention;

FIG. 5 is a block diagram of a system for decoder multiplexing in accordance with an embodiment of the present invention;

FIG. 6 is a flowchart of a process for decoder multiplexing in accordance with an embodiment of the present invention;

FIG. 7 is an illustration of the circular buffer of FIG. 5 in accordance with an embodiment of the present invention; and

FIGS. 8A-8D depict a close-up view of the circular buffer of FIG. 7 in accordance with an embodiment of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

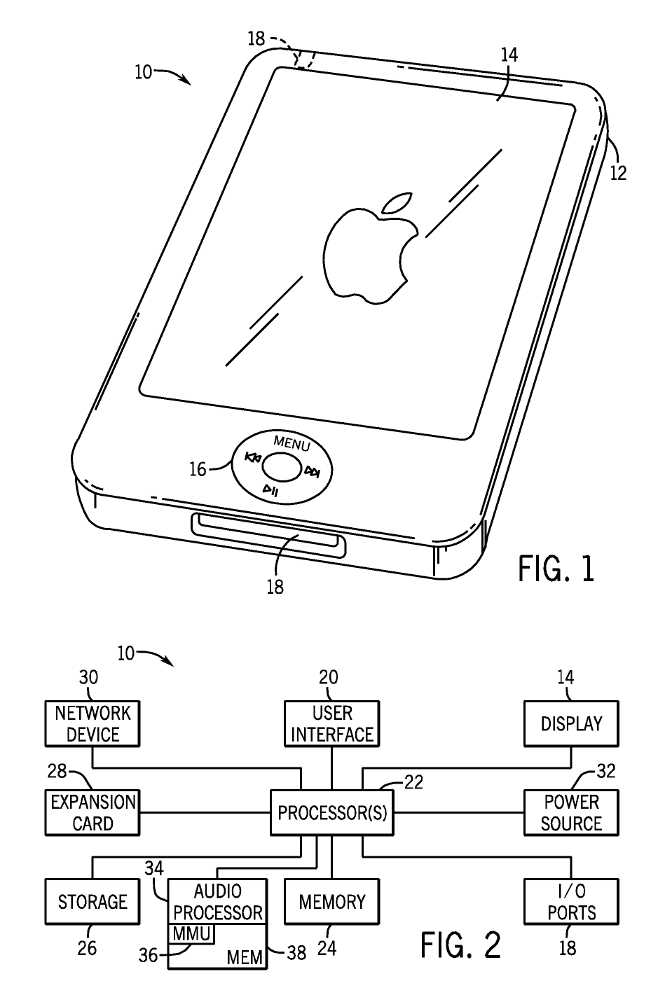

Turning now to the figures, FIG. 1 depicts an electronic device 10 in accordance with one embodiment of the present invention. In some embodiments, the electronic device 10 may be a media player for playing music and/or video, a cellular phone, a personal data organizer, or any combination thereof. Thus, the electronic device 10 may be a unified device providing any one of or a combination of the functionality of a media player, a cellular phone, a personal data organizer, and so forth. In addition, the electronic device 10 may allow a user to connect to and communicate through the Internet or through other networks, such as local or wide area networks. For example, the electronic device 10 may allow a user to communicate using e-mail, text messaging, instant messaging, or using other forms of electronic communication. By way of example, the electronic device 10 may be a model of an ipod® having a display screen or an iphone® available from Apple Inc.

In certain embodiments the electronic device 10 may be powered by a rechargeable or replaceable battery. Such battery-powered implementations may be highly portable, allowing a user to carry the electronic device 10 while traveling, working, exercising, and so forth. In this manner, a user of the electronic device 10, depending on the functionalities provided by the electronic device 10, may listen to music, play games or video, record video or take pictures, place and take telephone calls, communicate with others, control other devices (e.g., the device 10 may include remote control and/or Bluetooth functionality, for example), and so forth while moving freely with the device 10. In addition, in certain embodiments the device 10 may be sized such that it fits relatively easily into a pocket or hand of the user. In such embodiments, the device 10 is relatively small and easily handled and utilized by its user and thus may be taken practically anywhere the user travels. While the present discussion and examples described herein generally reference an electronic device 10 which is portable, such as that depicted in FIG. 1, it should be understood that the techniques discussed herein may be applicable to any electronic device having audio playback capabilities, regardless of the portability of the device.

In the depicted embodiment, the electronic device 10 includes an enclosure 12, a display 14, user input structures 16, and input/output connectors 18. The enclosure 12 may be formed from plastic, metal, composite materials, or other suitable materials or any combination thereof. The enclosure 12 may protect the interior components of the electronic device 10 from physical damage, and may also shield the interior components from electromagnetic interference (EMI).

The display 14 may be a liquid crystal display (LCD) or may be a light emitting diode (LED) based display, an organic light emitting diode (OLED) based display, or other suitable display. Additionally, in one embodiment the display 14 may be a touch screen through which a user may interact with the user interface.

In one embodiment, one or more of the user input structures 16 are configured to control the device 10, such as by controlling a mode of operation, an output level, an output type, etc. For instance, the user input structures 16 may include a button to turn the device 10 on or off. In general, embodiments of the electronic device 10 may include any number of user input structures 16, including buttons, switches, a control pad, keys, knobs, a scroll wheel, or any other suitable input structures. The input structures 16 may work with a user interface displayed on the device 10 to control functions of the device 10 or of other devices connected to or used by the device 10. For example, the user input structures 16 may allow a user to navigate a displayed user interface or to return such a displayed user interface to a default or home screen.

The electronic device 10 may also include various input and/or output ports 18 to allow connection of additional devices. For example, a port 18 may be a headphone jack that provides for connection of headphones. Additionally, a port 18 may have both input/output capabilities to provide for connection of a headset (e.g. a headphone and microphone combination). Embodiments of the present invention may include any number of input and/or output ports, including headphone and headset jacks, universal serial bus (USB) ports, Firewire or IEEE-1394 ports, and AC and/or DC power connectors. Further, the device 10 may use the input and output ports to connect to and send or receive data with any other device, such as other portable electronic devices, personal computers, printers, etc. For example, in one embodiment the electronic device 10 may connect to a personal computer via a USB, Firewire, or IEEE-1394 connection to send and receive data files, such as media files.

Turning now to FIG. 2, a block diagram of components of an illustrative electronic device 10 is shown. The block diagram includes the display 14 and I/O ports 18 discussed above. In addition, the block diagram illustrates the user interface 20, one or more processors 22, a memory 24, storage 26, card interface(s) 28, networking device 30, and power source 32.

As discussed herein, in certain embodiments the user interface 20 may be displayed on the display 14, and may provide a means for a user to interact with the electronic device 10. The user interface may be a textual user interface, a graphical user interface (GUI), or any combination thereof, and may include various layers, windows, screens, templates, elements or other components that may be displayed in all or some of the areas of the display 14.

The user interface 20 may, in certain embodiments, allow a user to interface with displayed interface elements via the one or more user input structures 16 and/or via a touch sensitive implementation of the display 14. In such embodiments, the user interface provides interactive functionality, allowing a user to select, by touch screen or other input structure, from among options displayed on the display 14. Thus the user can operate the device 10 by appropriate interaction with the user interface 20.

The processor(s) 22 may provide the processing capability required to execute the operating system, programs, user interface 20, and any other functions of the device 10. The processor(s) 22 may include one or more microprocessors, such as one or more “general-purpose” microprocessors, a combination of general and special purpose microprocessors, and/or ASICS. For example, the processor(s) 22 may include one or more reduced instruction set (RISC) processors, such as a RISC processor manufactured by Samsung, as well as graphics processors, video processors, and/or related chip sets.

Embodiments of the electronic device 10 may also include a memory 24. The memory 24 may include a volatile memory, such as RAM, and a non-volatile memory, such as ROM. The memory 24 may store a variety of information and may be used for a variety of purposes. For example, the memory 24 may store the firmware for the device 10, such as an operating system for the device 10 and/or any other programs or executable code necessary for the device 10 to function. In addition, the memory 24 may be used for buffering or caching during operation of the device 10.

The device 10 in FIG. 2 may also include non-volatile storage 26, such as ROM, flash memory, a hard drive, any other suitable optical, magnetic, or solid-state storage medium, or a combination thereof. The storage 26 may store data files such as media (e.g., music and video files), software (e.g., for implementing functions on device 10), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), telephone information (e.g., telephone numbers), and any other suitable data.

The embodiment in FIG. 2 also includes one or more card slots 28. The card slots 28 may receive expansion cards that may be used to add functionality to the device 10, such as additional memory, I/O functionality, or networking capability. The expansion card may connect to the device 10 through any type of connector and may be accessed internally or externally to the enclosure 12. For example, in one embodiment the card may be a flash memory card, such as a SecureDigital (SD) card, mini- or microSD, CompactFlash card, Multimedia card (MMC), etc. Additionally, in some embodiments a card slot 28 may receive a Subscriber Identity Module (SIM) card, for use with an embodiment of the electronic device 10 that provides mobile phone capability.

The device 10 depicted in FIG. 2 also includes a network device 30, such as a network controller or a network interface card (NIC). In one embodiment, the network device 30 may be a wireless NIC providing wireless connectivity over any 802.11 standard or any other suitable wireless networking standard. The network device 30 may allow the device 10 to communicate over a network, such as a LAN, WAN, MAN, or the Internet. Further, the device 10 may connect to and send or receive data with any device on the network, such as other portable electronic devices, personal computers, printers, etc. For example, in one embodiment, the electronic device 10 may connect to a personal computer via the network device 30 to send and receive data files, such as media files. Alternatively, in some embodiments the electronic device may not include a network device 30. In such an embodiment, a NIC may be added into card slot 28 to provide similar networking capability as described above.

The device 10 may also include or be connected to a power source 32. In one embodiment, the power source 32 may be a battery, such as a Li-Ion battery. In such embodiments, the battery may be rechargeable, removable, and/or attached to other components of the device 10. Additionally, in certain embodiments the power source 32 may be an external power source, such as a connection to AC power and the device 10 may be connected to the power source 32 via the I/O ports 18.

To process and decode audio data, the device 10 may include an audio processor 34. In one implementation the audio processor 34 may include and be referred to as a “hardware decoder,” as one of the primary functions of the processor 34 is to decode audio data encoded in a particular format. However, it should be appreciated that the audio processor 34 may also include any other suitable functions and capabilities. Thus, in some embodiments, the audio processor 34 may also be referred to as a codec, an accelerator, etc. In some embodiments, the audio processor 34 may include a memory management unit 36 and a dedicated memory 38, i.e., memory only accessible for use by the audio processor 34. The memory 38 may include any suitable volatile or non-volatile memory, and may be separate from, or a part of, the memory 24 used by the processor 22. In other embodiments, the audio processor 34 may share and use the memory 24 instead of or in addition to the dedicated audio memory 38. The audio processor 34 may include the memory management unit (MMU) 36 to manage access to the dedicated memory 38.

As described above, the storage 26 may store media files, such as audio files. In an embodiment, these media files may be compressed, encoded and/or encrypted in any suitable format. Encoding formats may include, but are not limited to, MP3, AAC, ACCPlus, Ogg Vorbis, MP4, MP3Pro, Windows Media Audio, or any suitable format.

To playback media files, e.g., audio files, stored in the storage 26, the device 10 may decode the audio files before output to the I/O ports 18. As used herein, the term decoding may include decompressing, decrypting, or any other technique to convert data from one format to another format. The decoding is performed via the audio processor 34, and each encoded file may be decoded through the execution of a decoder, i.e., codec, on the audio processor 34. After decoding, the data from the audio files may be streamed to memory 24, the I/O ports 18, or any other suitable component of the device 10 for playback.

In the transition between two audio streams during playback, the device 10 may crossfade audio streams, such as by “fading out” playback of a first audio stream while simultaneously “fading in” playback of a second audio stream. Each audio stream may be a decoded stream from encoded data such as an audio file, and each stream may be decoded from the same or a different format. For example, the first audio stream may be decoded from an MP3 audio file, and the second audio stream may be decoded from an AAC audio file. After the second audio stream is faded in, and the first audio stream is faded out, the transition to any additional audio streams may also include crossfading.

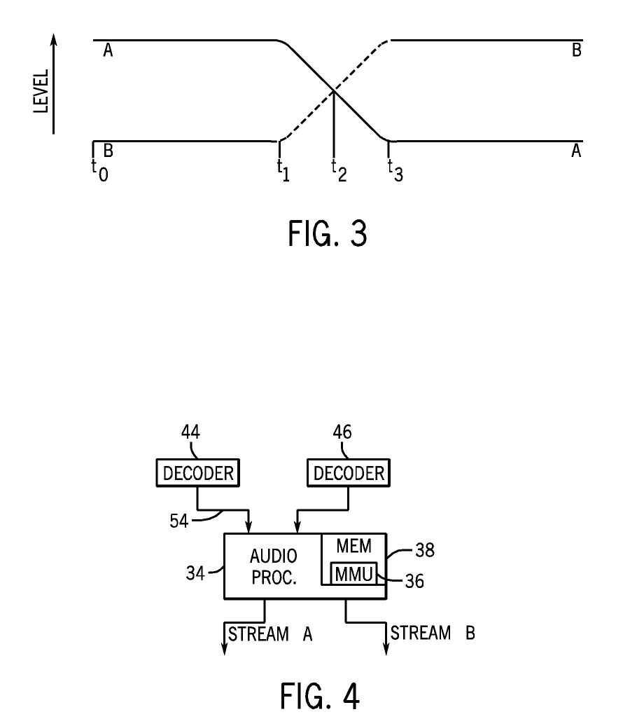

FIG. 3 is a graphical illustration of the crossfading of two audio streams A and B. The “level” of each stream A and B is represented on the y-axis of FIG. 3. In an embodiment, the level may refer to the output volume, power level, or other parameter of the audio stream that determines the level of sound a user would hear at the real-time output of the streams A and B. The combined streams of A and B as illustrated in FIG. 3 and during playback may be referred to as the “mix.”

The x-axis of FIG. 3 indicates the time elapsed during playback of the audio streams A and B. For example, at t0, the first stream A is playing at the highest level, and stream B is playing at the lowest level or is not playing at all. The point t0 represents normal playback of stream A without any transition. At point t1, the crossfading of streams A and B begins. For example, point t1 may occur if stream A is reaching the end of the duration of the stream (for example, the last ten seconds of a song), and the device 10 can provide a fading transition between stream A and stream B to the user.

At point t1, stream B begins to increase in level and stream A begins to decrease in level. Between t1 and t2, the level of stream A is reduced, while the level of stream B increases, crossfading the two streams A and B. At t3, stream A has ended or is reduced to the lowest level, and stream B is at the highest level. As stream B nears the end of its duration, another stream may be added to the mix using the crossfading techniques described above, e.g., stream B is decreased in level and the next stream is increased in level.

Because each audio stream A and B may be decoded from data, e.g., audio files, in different formats, the audio processor 34, in one embodiment, may enable crossfading by switching between decoders, i.e., codecs, in the transition during playback. Switching between decoders during the decoding process may be referred as “multiplexing.” As explained further below, to provide uninterrupted real-time output and crossfading between two decoded audio streams, the decoding for each stream may be faster than the decoding performed for one stream alone. To ensure no interruptions in real-time output, each stream may be decoded at least twice as fast as decoding one stream. In an embodiment, the audio processor 34 may be capable of decoding one audio stream as fast as necessary to maintain uninterrupted real-time output.

FIG. 4 depicts a simplified block diagram of decoder multiplexing in accordance with an embodiment of the present invention. A decoder 44 and a decoder 46 are each multiplexed in the audio processor 34. The decoders 44 and 46 may each be decoders for different formats. For example, the decoder 44 may be an MP3 codec, and the decoder 46 may be an AAC codec. The audio processor 34 may load, execute, and multiplex the decoders 44 and 46. The output from the audio processor 34 may be a decoded audio stream A and a decoded audio stream B. It should be appreciated that a decoded audio stream may include or be referred to as decoded “frames,” wherein each frame is some unit of data of the stream. In various formats, frames need not be the same size, and may vary in size within or among each decoded stream.

Further, as described below, to enable multiplexing the audio processor 34 can stop decoding a stream, store the state, and load a new state and decoder, e.g., decoder 46, for a second stream. This multiplexing may be repeated several times during decode and output of audio streams A and B. Additionally, in an embodiment in which only one of stream A or B is decoded at one time by the audio processor 34, the processor 34 may only include enough processing capability and dedicated memory 38 for decoding one stream, reducing the memory requirements of the processor 34. Further, if the crossfading transition is extended, no additional memory is required, as the processor 34 can switch between decoders 44 and 46 and decode stream A or B to extend the crossfade “on the fly”.

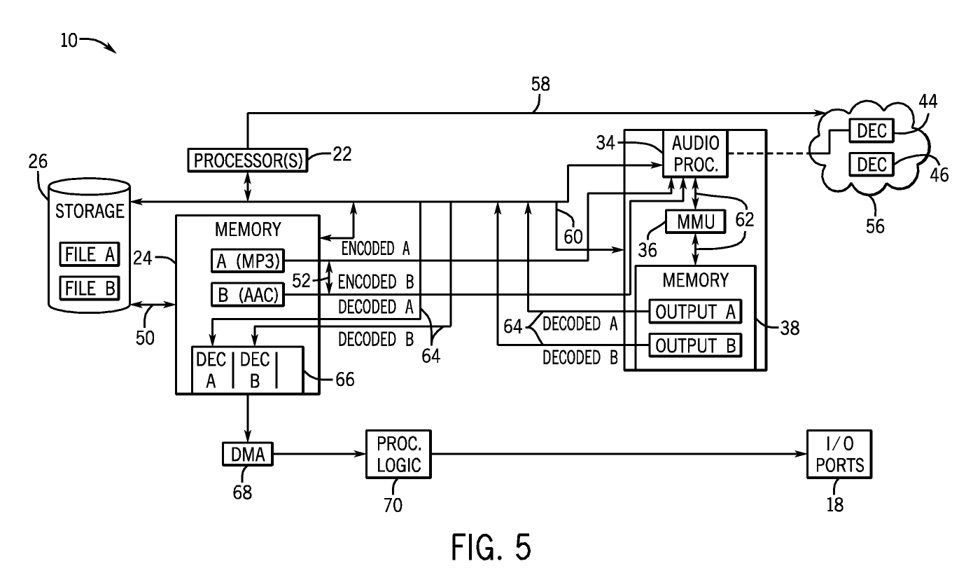

FIG. 5 is a block diagram of the device 10 illustrating decoding, output, and playback of audio streams using components of the device 10. It should be appreciated that illustrated components of device 10 (and any other components described above) may be coupled together via an internal bus or any suitable connection in the device 10. As described above, audio data, e.g., audio tracks, may be stored as encoded data, e.g., audio files, on storage 26, and each file of encoded data may be encoded in a different format. For the purposes of the following discussion, two audio files A and B are shown in FIG. 5, but any number of audio files may be stored, decoded, output, and played back by the device 10. For example, audio file A may be encoded using the MP3 codec, and audio file B may be encoded using the AAC codec. As indicated by arrow 50, upon initiation of playback, audio file A and audio file B may be copied from the storage 26 into the memory 24 of the device 10. Playback of one or more audio files may be initiated by a user through the user interface 20 of the device 10, or through any other action, and received by the processor 22. In some embodiments, for example, a user may initiate playback of a playlist referencing one or more audio files, wherein audio file A and audio file B may correspond to sequential audio files of the playlist.

The data from the audio files A and B may be streamed from main memory 24 to the audio processor 34 for decoding, as illustrated by lines 52. In one embodiment, the data from the memory 24 may be transmitted to the audio processor 34 via a DMA request. The audio processor 34 may execute the decoders 44 and 46 to decode the encoded audio streams A and B respectively into a decoded audio stream. In an embodiment, the decoders, e.g., codecs, may be stored in the audio memory 38, the main memory 24, and/or the storage 26. For example, codecs may be stored in the storage 26 and loaded into main memory 24 and/or audio memory 38 upon initiation of the decoding process.

As described above, the audio processor 34 may multiplex decoders 44 and 46, alternately decoding audio streams A and B, as illustrated in area 56. The logic to control multiplexing, e.g. switching, of the decoders 44 and 46 may be implemented in the processor 22 and/or the audio processor 34. For example, the processor 22 may analyze the playback of the decoded audio streams A and B, the memory 24, and signal to the audio processor 34 when to switch decoding from stream A to stream B and vice-versa, as illustrated by line 58. Additionally, a debugging and/or control signal may be provided to the audio memory 38, as illustrated by line 60.

During the decoding process, the audio processor 34 may read or write data into and out of the dedicated audio memory 38. The audio processor 34 may interface with the audio memory 38 though a memory management unit 36, as illustrated by lines 62. The memory management unit 36 manages access to the audio memory 38 and can provide data out the audio memory 38 for decoding, such as decoded streams, codecs, etc., to the audio processor 34. The output from the audio processor 34, decoded output streams A and B may be stored in the audio memory 38.

Output streams A and B from the audio processor 34, i.e., decoded data streams A and B, may be provided to a buffer, such as a circular buffer 66, in the main memory 24 of the device 10, as illustrated by lines 64. As explained further below, the circular buffer 66 stores decoded streams A and B to ensure that an adequate duration of either stream is available for playback and for crossfading during playback. The decoded streams A and B may be read out of the circular buffer 66, such as through a DMA request 68, and output to an digital-to-analog (D/A) converter and/or other processing logic 70. A mix of the streams A and B may be output to an I/O port 18 of the device 10, such as a headphone port, headset port, USB port, etc. In other embodiments, a mix of the streams A and B may be output digitally over I/O ports 18, e.g., omitting the D/A converter of the processing logic 70.

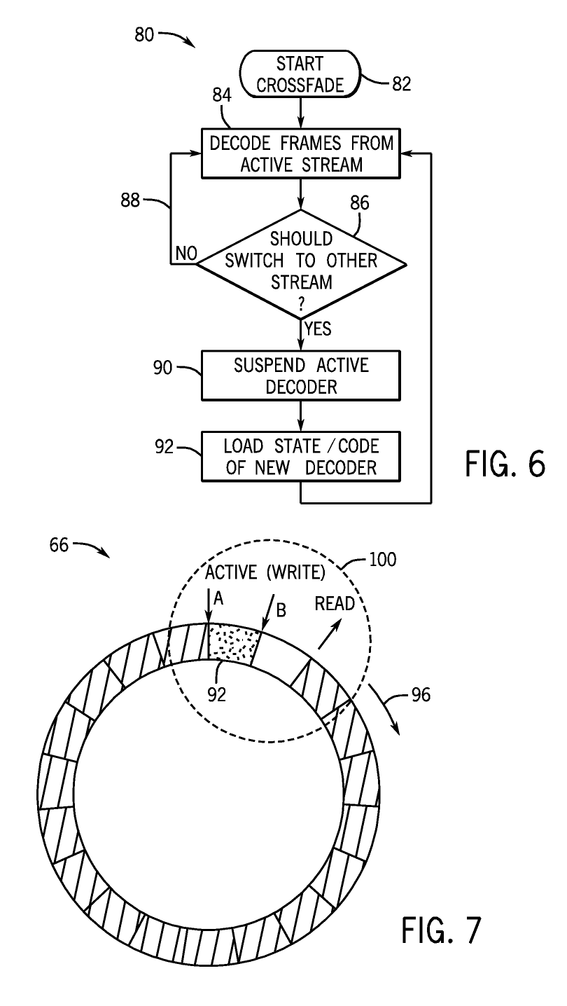

FIG. 6 depicts a flowchart of a process 80 for decoder multiplexing in accordance with an embodiment of the present invention. In an embodiment, the process 80 may be implemented in the audio processor 34, the processor(s) 22, or any other suitable processor of the device 10. Initially, the process 80 may start the crossfade transition (block 82), such as in response to an approaching end of an audio stream, selection of another audio stream (e.g., selection of another audio track) automatically or in response to a user request, or any other event. The process 80 decodes frames from the active audio stream (block 84), e.g., audio stream A, using the decoder for the format of the encoded stream. The process 80 determines if the audio processor 34 (or other processor performing the decoding) should switch decoding to the other audio stream, e.g., audio stream B, of the crossfade (decision block 86). This determination may be on based on an analysis of the buffer 66 of the memory 24, as discussed further below. If the process 80 should not switch decoders, decoding of the active stream (block 82) continues, as indicated by line 88.

If the process 80 determines to switch decoding to the other stream of the crossfade, e.g., audio stream B, the current decoder is suspended (block 90). The audio processor 34 (or other processor) may load a state and codec for another decoder (block 92), such as from the dedicated audio memory 38. The active stream being decoded is now the other stream of the crossfade, e.g., stream B. After the state and code for the other decoder are loaded, the process 80 continues decoding frames from the active stream (block 84), e.g., audio stream B. In some embodiments, switching of the decoders may also be based on additional parameters of the device 10, such as battery life, the amount of time to switch decoders, the amount of processing overhead to switch decoders, etc. These and similar additional factors may be considered the “cost” of switching between decoders. Additionally, the different frame size of the encoded formats may be considered when multiplexing and switching decoders. For example, the number of samples in a decoded MP3 frame is 1152 samples per frame, and the number of samples in a decoded AAC frame is 1024 samples per frame.

In other embodiments, the penalty of switching of the decoders (e.g., codecs) as illustrated in FIG. 6 may be minimized or eliminated. For example, if both decoders can be stored in the dedicated audio memory 38, the decoders do not need to be copied into the memory 38 each time the decoders are switched. In such an embodiment, the audio processor 34 may be configured to execute code from a different location in the memory 38, depending on which decoder is to be used. The memory location and access may be enabled by the MMU 36 of the audio processor 34, which can provide access to the appropriate decoder based on the memory location. In this embodiment, the overhead and resources used to multiplex decoders may be substantially reduced. Additionally, in other embodiments, the states for each decoder used by the processor 34 may also be stored in the dedicated audio memory 38 of the processor 34, further reducing overhead and resources used.

FIG. 7 is an illustration of the circular buffer 66 in accordance with an embodiment of the present invention. As described above, the circular buffer 66 stores the decoded streams A and B output from the audio processor 34 for playback, as illustrated by the shaded areas of FIG. 7. The shaded area up to arrow A indicates those portions of the buffer 66 containing data of decoded audio stream A and decoded audio stream B. The shaded area up to line B indicates those portions of the buffer 66 containing data of decoded audio stream B. During playback of the stream A, stream B, or both (such as during the crossfade discussed above), the circular buffer 66 is simultaneously being read from and written to. The READ arrow indicates the read pointer of the read request as it moves around the buffer 66 as indicated by line 96. The ACTIVE arrow, e.g., the endpoint of data for stream A in the presently illustrated embodiment, indicates the write pointer of the write operation writing to the buffer 66. The write pointer also moves around the buffer 66 in the direction indicated by arrow 96.

The processor(s) 22 (or other processor of the device 10) may determine when to switch decoders, and which stream to decode, based on the data for each decoded stream A and B stored in the circular buffer 66. In one embodiment, the decoders executed by the audio processor 34 may be switched such that the stream that is behind in time since the start of the crossfade is the active stream, i.e., the stream being currently decoded by the audio processor 34. For example, if 5.01 seconds of stream A have been decoded and stored in the buffer 66, and 4.95 seconds of stream B have been decoded and stored in the buffer 66, the audio processor 34 will decode stream B until the amount of data for stream B stored in the circular buffer 66, e.g., the amount of playback time, at least exceeds that of stream A.

In some embodiments, however, the decoder multiplexing and switching may be a relatively resource-intensive process. For example, if DMA requests are used to transmit audio streams to the audio processor 34, the decoder switching process may allow the audio processor 34 to decode multiple frames of data before stopping the input stream (and clearing any buffers), stopping the decoding, switching to another decoder, and starting to transmit the frames of the new stream via DMA requests. Additionally, the amount of time that the decoding is ahead of real-time output also affects the decision to switch decoders. If the read pointer is permitted to get too close to the last time that data has been decoded for both streams (such as near the ACTIVE arrow noted above), the device 10 may “starve” on one of the streams depending on how long it takes to switch decoders, e.g., no data is available for one of the streams stored in the buffer 66. For example, as shown in FIG. 7, if the read pointer passes the active pointer for stream A, such as at point 92, there is still data produced by stream B, which could be fading in or out during a crossfade. However, there is no longer any data for stream A at the point 92 of the buffer 66, which may cause an undesirable audio artifact in the real-time output of stream A.

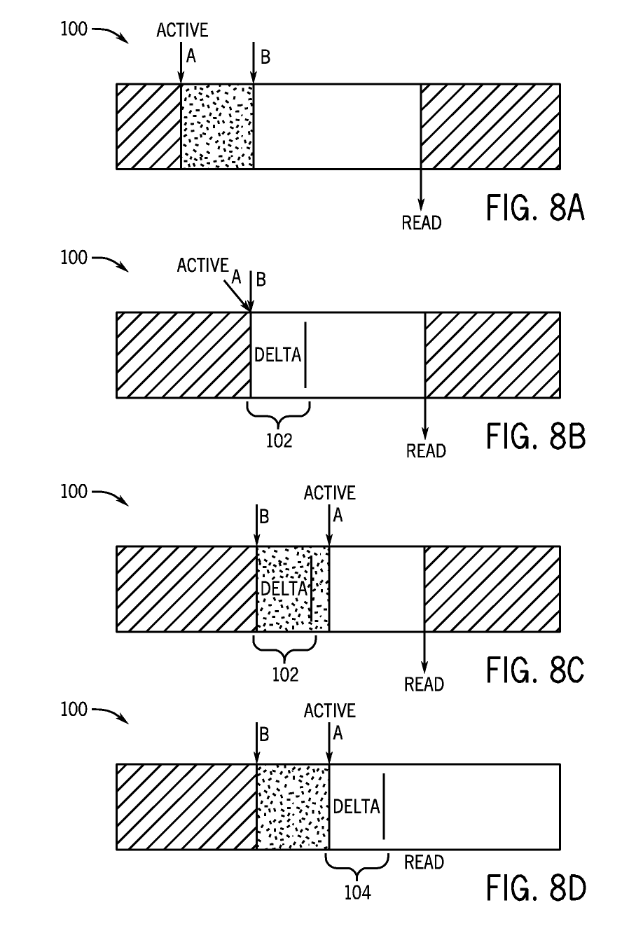

FIGS. 8A-8D depict circular portion 100 of the circular buffer 4 of FIG. 7 in greater detail, illustrating a technique for storing two audio streams A and B in the circular buffer 66 in accordance with an embodiment of the present invention. As described above, the shaded area up to arrow A indicates the portion of the buffer 66 containing a mix of data of decoded audio streams A and B, and the shaded area up to arrow B indicates the portion of the buffer 66 containing data of decoded audio stream B. To playback data, e.g., a mix that may include audio stream A and/or audio stream B, the stored data may be read from the buffer 66.

As shown in FIG. 8A, stream A is the active stream being actively decoded by the audio processor 34, e.g., stream A is written to circular buffer 66 at the ACTIVE arrow. As shown in FIG. 8B, stream A may be decoded and written to the circular buffer 66 until the data of stream A reaches the end of the data of stream B. As also shown in FIG. 8B, an “efficiency delta” 102 of the circular buffer 66 may be determined based on parameters of the device 10 and the decoding and playback processes. The efficiency delta 102 may correspond to an amount of data in the buffer 66, duration of time of a stream, or any other suitable unit. The efficiency delta 102 may be determined based on the duration of the crossfade, the playback duration of stream A (based on the amount of data of stream A in the buffer 66), the playback duration of stream B (based on the amount of data of stream B in the buffer 66), the speed of the decoding process, the amount of time needed to switch between decoding of streams A and B, or any other suitable parameters. The efficiency delta 102 indicates the minimum amount of decoded data of a stream to be stored in the buffer 66 to ensure smooth crossfading during transition to a second stream also stored in the buffer 66.

As shown in FIG. 8C, after the data of stream A reaches the end of the data of stream B, stream A continues to be decoded and the decoded data is written to the buffer 66 until the decoded data stream A passes the efficiency delta 102, as shown by the ACTIVE arrow. Decoding and writing decoded data of stream A past the efficiency delta ensures that enough data of stream A is present in the buffer 66 to allow switching of decoders in the audio processor 34 and initiation of the decoding of stream B. As shown in FIG. 8D, after the data of stream A written to the buffer 66 passes the efficiency delta 102, stream B becomes the active stream, i.e., the currently decoded stream, as indicated by the ACTIVE arrow. Stream B is decoded and written to the buffer until another efficiency delta 104 is reached. After the next efficiency delta 104 is reached by data from stream B, stream A may become the actively decoded stream and the decoders switched in the audio processor 34. Decoder switching and decoding of alternating streams based on the efficiency delta may continue until the crossfade is complete or the audio streams stop playback. In this manner, the decoders may be switched (multiplexed) based on the efficiency delta of the buffer 66, ensuring that enough decoded data for each stream of a crossfade is present in the buffer 66.

What is claimed is:

1. An electronic device, comprising:
a memory buffer;
a storage structure including a plurality of executable routines, the routines including instructions to alternately decode at least first and second streams of data and to store the decoded first and second streams of data in the memory buffer, wherein the instructions alternate between decoding the first and second streams such that simultaneous playback of the first and second streams of decoded data can proceed without interruption; and
a processor configured to execute the routines stored on the storage structure.

2. The device of claim 1, wherein the memory buffer comprises a circular buffer.

3. The device of claim 1, wherein the first and second streams of data are stored on the storage structure.

4. The device of claim 1, comprising a plurality of decoders stored in a memory or on the storage structure.

5. The device of claim 1, wherein the memory buffer comprises dynamic random access memory, flash memory, or any combination thereof.

6. The device of claim 1, wherein the storage structure comprises one or more of a hard drive, an optical storage medium, a solid-state memory device, or a magnetic storage medium.

7. The device of claim 1, wherein the state of the processor is cached when the processor is alternated from decoding the first stream to decoding the second stream.

8. The device of claim 7, wherein the cached state of the processor is reloaded when the processor is subsequently alternated from decoding the second stream to decoding the first stream.

9. A method, comprising:
decoding a first stream of data encoded in a first format via a first decoder;
storing the decoded first stream of data;
decoding data of a second stream encoded in a second format via the second decoder;
storing the decoded second stream of data; and
switching between the first decoder and the second decoder based at least on a differential between a playback duration associated with the stored decoded first and second streams of data.

10. The method of claim 9, wherein the act of switching is also based at least in part on a performance cost associated with switching from the first decoder and the second decoder.

11. The method of claim 9, wherein the act of switching is also based at least in part on a performance cost that accounts for at least one of battery life or an amount of time associated with switching between the first decoder and the second decoder.

12. The method of claim 9, wherein the act of switching comprises loading a previously cached state of a processor.

13. The method of claim 9, wherein the first format is different from the second format.

14. The method of claim 9, wherein the acts of decoding the first stream and the second stream are performed by respective first and second codecs.

15. The method of claim 9, wherein switching between the first decoder and the second decoder comprises executing code for a respective first or second codec on a processor.

16. The method of claim 9, comprising converting the decoded data of the first and second streams to one or more respective analog streams.

17. The method of claim 9, comprising playing an audio or video signal derived from both the decoded first and second streams of data.

18. A computer-readable storage medium comprising instructions for:
decoding a first stream of data encoded in a first format via a first decoder;
storing the decoded first stream of data;
decoding data of a second stream encoded in a second format via the second decoder;
storing the decoded second stream of data; and
switching between the first decoder and the second decoder based at least on a differential between a playback duration associated with the stored decoded first and second streams of data.

19. The computer-readable storage medium of claim 18, wherein the storage medium comprises one or more of a hard drive, an optical storage medium, a solid-state memory device, or a magnetic storage medium.

20. A method, comprising:
decoding a first stream of data;
storing the decoded data of the first stream in a memory; and
switching to decode a second stream of data based at least on the amount of decoded data of the first stream stored in the memory.

21. The method of claim 20, wherein the first stream and the second stream are encoded in the same format.

22. The method of claim 20, wherein the first stream is encoded in a first format and the second stream is encoded in a different format.

23. The method of claim 20, comprising generating a mixed playback signal based on the stored decoded first and second streams of data.

24. A computer-readable storage medium comprising instructions for:
decoding a first stream of data;
storing the decoded data of the first stream in a memory; and
switching to decode a second stream of data based at least on the amount of decoded data of the first stream stored in the memory.
